(19) United States
(12) Patent Application Publication
(10) Pub. No.: US 2018/0279568 A1
(43) Pub. Date: Oct. 4, 2018

(54) HORTICULTURAL METHOD AND APPARATUS

(71) Applicant: 9934294 Canada Inc., Saint-Philippe (CA)

(72) Inventor: Gilles Dumont, Saint-Philippe (CA)

(73) Assignee: 9934294 Canada Inc., Saint-Philippe, QC (CA)

(21) Appl. No.: 15/731,034

(22) PCT Filed: Oct. 16, 2015
(86) PCT No.: PCT/CA2015/000538

§ 371 Date: Apr. 6, 2017

(30) Foreign Application Priority Data
Oct. 16, 2014 (CA) 2,867,551

(51) Int. Cl. A01G 31/04; A01G 7/04

(52) U.S. Cl. CPC A01G 31/047; A01G 7/045

(57) ABSTRACT

A method and an apparatus for optimizing the growth of a plant by taking a measurement of at least one property of a plant growing in a growing medium, calculating the optimal nutritional requirement of the plant based on the measurement, and then injecting an optimal amount of at least one substance selected from the group consisting of water, fertilizer and a combination of water and fertilizer into the container. A rotating drum apparatus is provided for the practice of the invention.

### FIELD OF THE INVENTION

The present invention relates to a plant growing apparatus and more particularly, relates to a plant growing apparatus using a rotating cylindrical drum.

### BACKGROUND OF THE INVENTION

The use of lamps for growing various types of plants is well known in the art. Hydroponics are used to grow a wide variety of plants. Generally, a non soil medium is utilized and the plant is provided the nutrients by means of a liquid. The plant roots are exposed to the liquid such that the plant may gather and utilize the nutrients.

A basic hydroponic system utilizes a flat surface with a light extending above. The plants grow in containers which usually lie in a horizontal plane. One problem with this type of arrangement is the amount of energy required for the lights which must be provided for each small groups of plants. This becomes relatively expensive with respect to electrical costs.

More recently, it has been proposed in the art to utilize a rotating drum which will carry the non soil medium in which the plant grows. The drum rotates about a light source normally placed interiorly of the drum so as to minimize electricity costs. In most systems, the drum is rotated and as it does so, it passes over a trough located at the bottom of the drum. The root system of the plant is immersed to provide the required moisture and nutrients. One disadvantage of such a system is that the plants continue to drip and ways for collecting the waste water must be provided. At the same time, this waste water contains nutrients which are wasted and can be a contaminant as far as local waters are concerned.

In such a rotating drum system, the maintenance of the correct light intensity is very important. The light intensity is exponentially related to the distance between the plant and the light.

The use of such plant growing systems as set forth above has become even more important with current water crises. At the present time, plants grown in a “natural” environment require sufficient moisture. Since this is not always delivered by nature through rain, watering systems must be provided. Again, however, the use of the water is not optimized and much is lost.

### SUMMARY OF THE INVENTION

It is an object of the present invention to provide a horticultural method to optimize the growth of plants while minimizing the resources used during the growth.

It is a further object of the present invention to provide a method for optimizing the growth of a plant wherein one can calculate the optimal nutritional requirement of the plant after taking a measurement of the plant and/or growth medium.

It is a further object of the present invention to provide a horticultural apparatus for practising the method set forth above.

According to one aspect of the present invention, there is provided a method for optimizing the growth of a plant comprising the steps of taking a measurement of at least one property of a plant growing in a growing medium, calculating the optimal nutritional requirement of the plant based on the measurement, and injecting an optimum amount of at least one substance selected from the group consisting of water, fertilizer, and a combination of water and fertilizer, into the container.

According to a further aspect of the present invention, there is provided a horticultural apparatus comprising a rotating drum having at least one ring, a drive system to rotatably drive the ring, a light source within the drum, a plurality of medium retaining members extending transversely of the ring, a detecting device mounted proximate to the ring for detecting a property of individual ones of the medium retaining members, a feeder associated with each of the medium retaining members to inject a substance into the medium retaining members.

As set forth above, the method of the present invention is to optimize the growth of a plant. This is achieved by taking a measurement of at least one property of a plant growing in a growing medium and subsequently calculating the optimal nutritional requirement of the plant. This will be followed by injecting or otherwise providing an optimal amount of at least one substance selected from the group consisting of water, fertilizer and a combination of water and fertilizer into the container having the plant therein.

The plant may be grown in any suitable growing medium. Such mediums are well known in the art and widely utilized and need not be discussed herein.

The method may take a measurement of at least one property of either the plant itself or the growing medium. This measurement may be taken directly or, in some instances, done remotely.

The property measured can vary. Thus, one could measure the moisture in the growing medium. Based on this measurement, a desired amount of water and/or nutrient may be injected or otherwise provided to the plant as is known in the art. In one embodiment, the foliage of the plant could be analyzed. This can be done remotely through the use of cameras or any other suitable instrument. A measurement of the foliage of the plant such as the colour can provide valuable information. Using various algorithms, one could calculate the requirements of the plant and use it to provide the desired dosage of water/nutrients.

It is also within the scope of the present invention to provide other materials as required. Thus, carbon dioxide could be supplied to the plants as may be required.

In practising the method of the present invention, there is preferably provided a horticultural apparatus of the rotating drum type. Such apparati are known in the art as exemplified by U.S. Pat. No. 7,401,437, the teachings of which are hereby incorporated by reference.

The horticultural apparatus will include a rotating drum which preferably rotates about a light source. The light source may be selected from among those well known in the art. Additionally, light emitting diodes (LED's) may be utilized.

In one embodiment of the present invention, different colour LED's may be employed. Thus, depending upon the particular growth stage of the plant, a different colour LED may be employed. For example, during germination, a first colour may be employed while during the development of the foliage, a different colour may be utilized.

### BRIEF DESCRIPTION OF THE DRAWINGS

Having thus generally described the invention, reference will be made to the accompanying drawings illustrating embodiments thereof, in which:

FIG. 1 is a perspective view of an embodiment of a horticultural apparatus according to the present invention;

FIG. 2 is a perspective detailed view of the injector apparatus used in the horticultural apparatus of FIG. 1;

FIG. 3 is a top plan view thereof;

FIG. 4 is a side view of a portion of the feeding device;

FIG. 5 is an exploded view of a transversely extending member, medium retaining device and blocking member;

FIG. 6 illustrates the individual lines and injectors;

FIG. 7 is a perspective view of the medium retaining member;

FIG. 8 is a perspective view of a further medium retaining member and transversely extending member; and

FIG. 9 is a perspective view of a further embodiment of a horticultural apparatus according to the present invention.

### DETAILED DESCRIPTION OF THE INVENTION

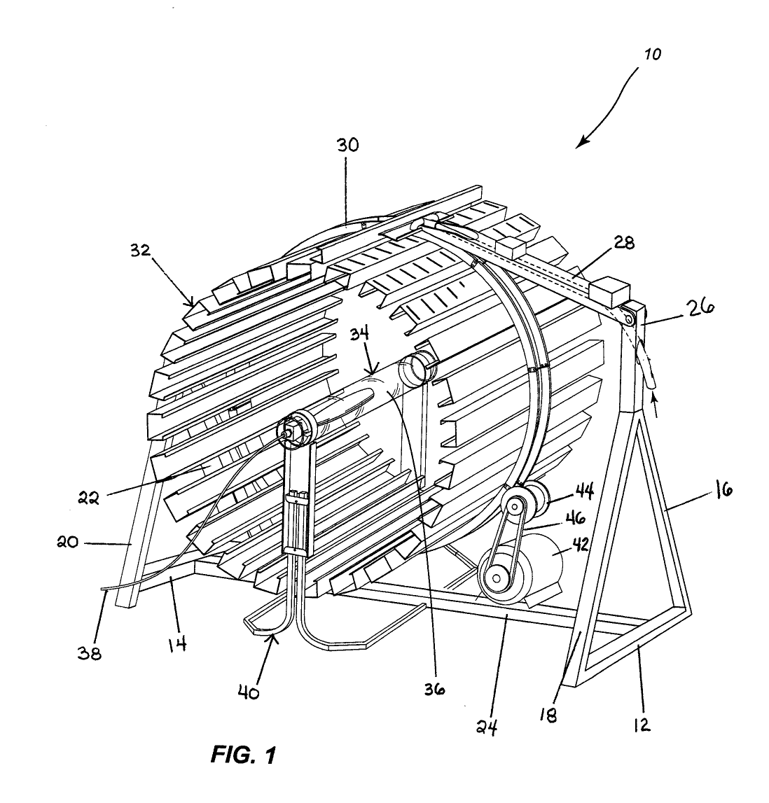

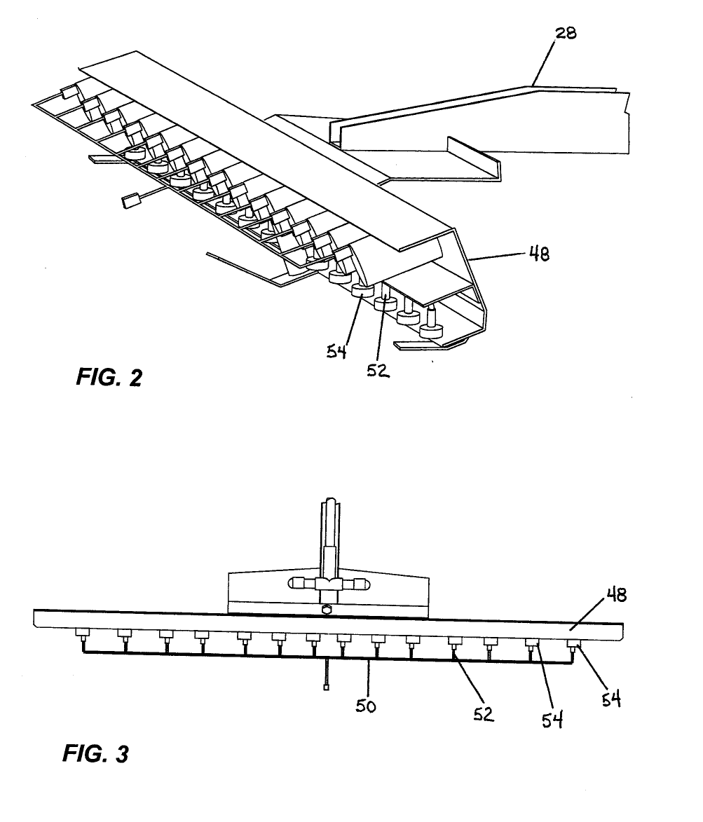

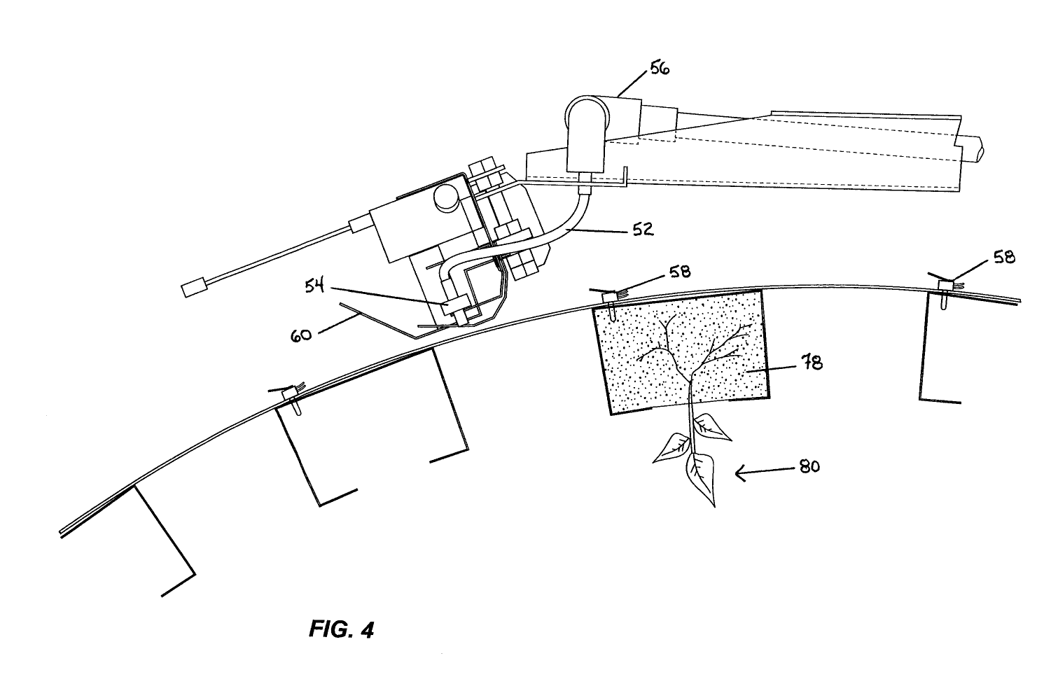

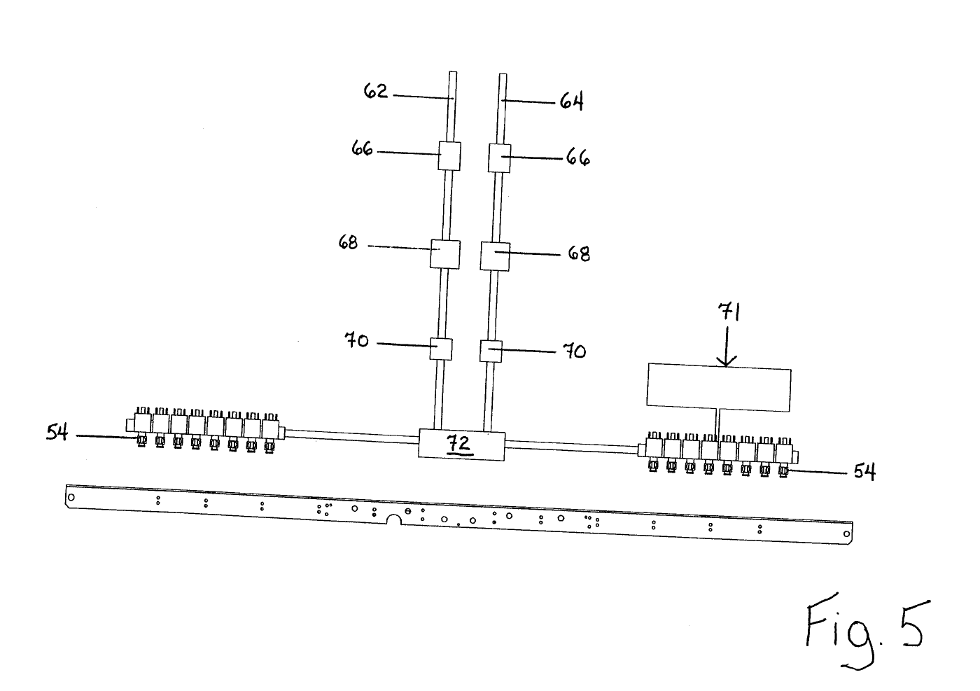

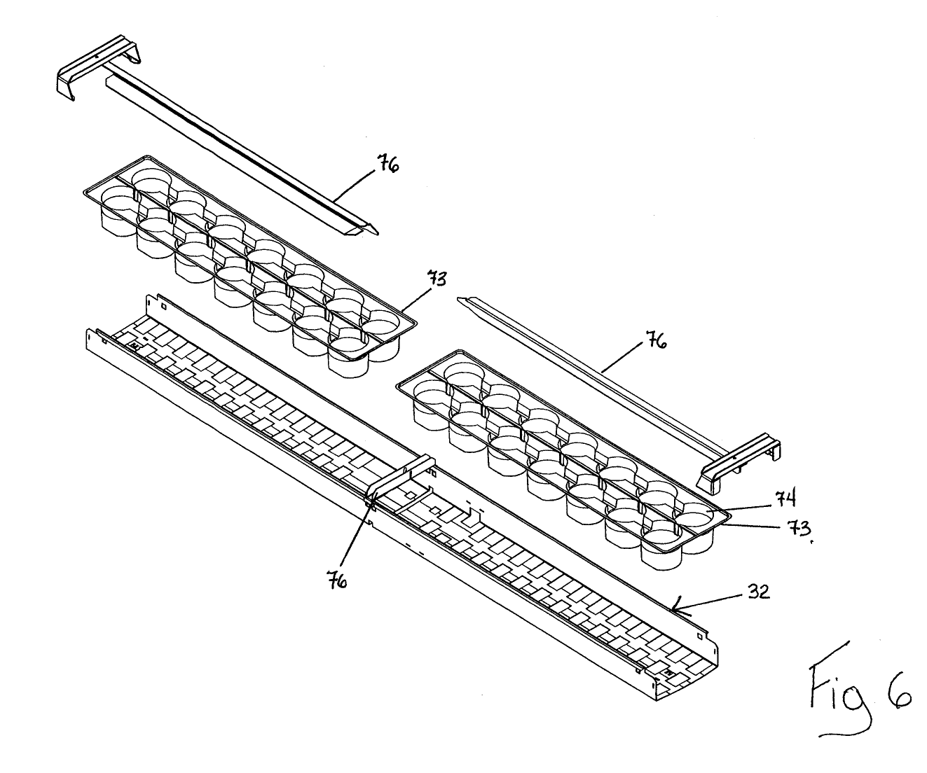

Referring to the drawings in greater detail and by reference characters thereto, there is illustrated in FIG. 1 a horticultural apparatus which is generally designated by reference numeral 10.

Horticultural apparatus 10 includes a plurality of frame members including a first lower horizontal frame member 12 secured together with a pair of upwardly extending frame members 16, 18 and which have a vertical frame member 26 forming a part thereof. On the other side, there is also provided a lower horizontal frame member 14 secured together with upwardly extending frame members 20, 22. A longitudinally extending frame member 24 secures the two side frames. Extending inwardly over the feed apparatus is an upper feed arm 28.

Horticultural apparatus 10 includes a ring 30 to which are secured a plurality of transversely extending members 32. Located internally of ring 30 is a light housing 34 having a light 36 mounted therein. Power supply 38 supplies light 36. The light assembly is supported by a light support device 40.

Horticultural apparatus 10 includes a motor 42 and a drive member 44 which is operatively connected with ring 30 to rotatably drive the same. A drive belt 46 extends between drive member 44 and motor 42 in a conventional arrangement.

Horticultural apparatus 10 is supplied with, as previously mentioned, a plurality of transversely extending members 32 each of which is adapted to retain a plurality of growing medium devices. Each plant is grown in its own particular cell and is individually fed and watered. To this end, the feed arrangement comprises a housing 48 having a manifold line 50 and a feed line 52. A plurality of injectors 54 are provided, each for an individual cell. A main feed 56 is provided.

Each cell has a moisture sensor 58 associated therewith. The feeding device includes a sensor trigger 60 which is adapted to contact each moisture sensor 58 to receive information as to the status of the cell. A sensor trigger 60 works in conjunction with moisture sensor 58.

The arrangement will include a feed for water 62 and a fertilizer feed 64 which meet at a manifold 72. Each line will have filter 66, valve 68 and flow meters 70 associated therewith. A computer card 71 provides control thereover.

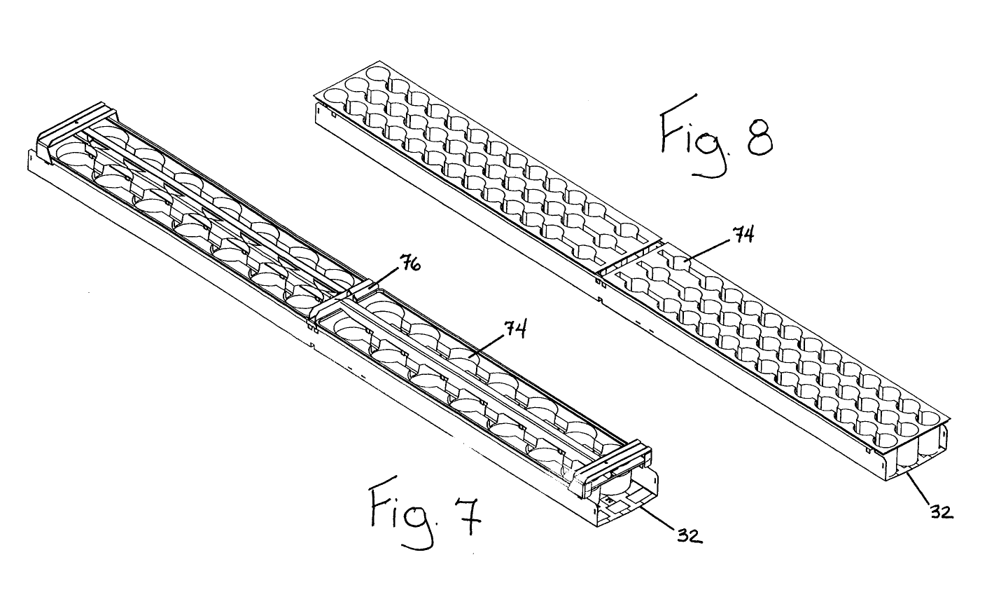

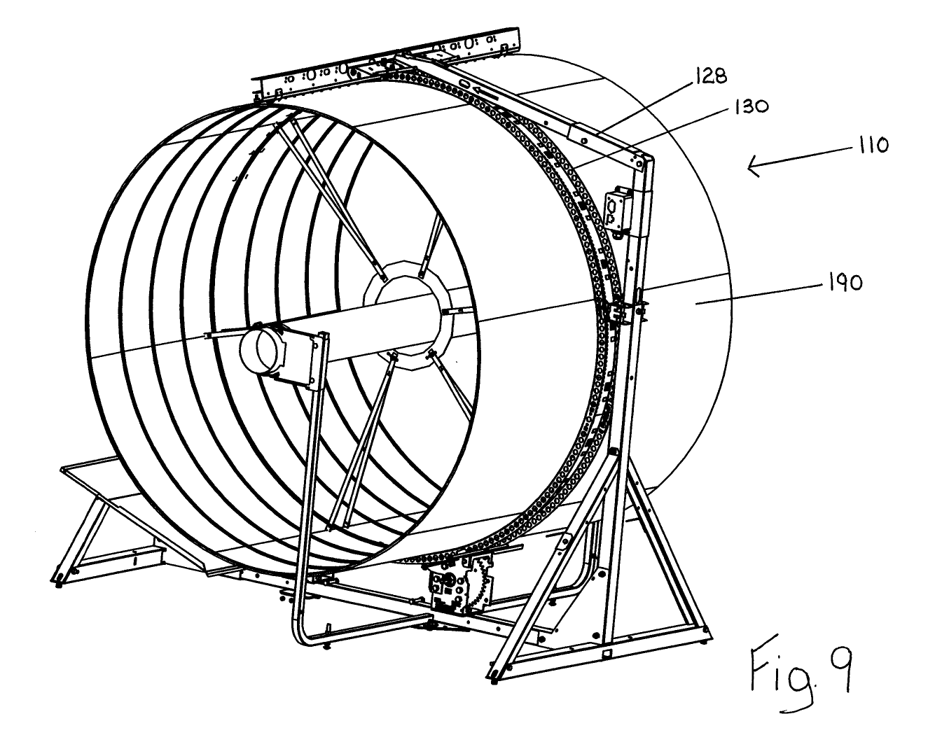

In the embodiment of FIG. 8, the horticultural apparatus is generally designated by reference numeral 110. It is similar to the previously described embodiment except that a plurality of solid pieces 190 will form the drum. Pieces 190 are preferably formed of an organic material such as coconut matting which in and by itself may function as a growth medium or alternatively, may have inter spaced areas which permit the germination and growing of a plant. This arrangement would provide for easy harvesting of young greens as a knife could sweep the surface and cut the plants in situ.

I claim:

1. A method for optimizing the growth of a plant comprising the steps of:
taking a measurement of at least one property of a plant growing in a growing medium;
calculating the optimal nutritional requirement of said plant based on said measurement; and
injecting an optimum amount of at least one substance selected from the group consisting of water, fertilizer, and a combination of water and fertilizer, into said container.

2. The method of claim 1 wherein the step of taking measurement of at least one property of a plant growing in a growing medium comprises the step of measuring the moisture in said growing medium.

3. The method of claim 2 wherein said step of taking measurement of at least one property of a plant growing in a growing medium comprises utilizing a probe inserted in said growing medium to measure said property.

4. The method of claim 1 wherein the step of taking measurement of at least one property of a plant growing in a growing medium comprises the step of measuring the health of said plant utilizing non destructive testing.

5. The method of claim 4 wherein said non destructive testing uses a camera to measure the health of foliar growth on said plant.

6. A method of claim 1 wherein the step of taking measurement of at least one property of a plant growing in a growing medium comprises the step of measuring multiple properties of said plant.

7. A horticultural apparatus comprising:
a rotating drum having at least one ring, a drive system to rotatably drive said ring, a light source within said drum;
a plurality of medium retaining members extending transversely of said ring;
a detecting device mounted proximate to said ring for detecting a property of individual ones of said medium retaining members;
a feeder associated with each of said medium retaining members to inject a substance into said medium retaining members.

8. The horticultural apparatus of claim 7 wherein said detecting device comprises a moisture detector.

9. The horticultural apparatus of claim 7 wherein said detecting device comprises a camera to detect the health of vegetation growing from said medium retaining members.

10. The horticultural apparatus of claim 7 wherein said light source within said drum includes light emitting diodes.
